(19) United States
(12) Patent Application Publication
(10) Pub. No.: US 2002/0163295 A1
(43) Pub. Date: Nov. 7, 2002

(54) Color display utilizing two complementary colors arranged in checker form

(76) Inventors: Wei Chen Liang, Hsinchu (TW); Pin Chang, Hinchu (TW); Heng Chung Wu, Hsinchu Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/847,422

(22) Filed: May 3, 2001

(51) Int. Cl. H01J 1/62; H01J 63/04

(52) U.S. Cl. 313/495

(57) ABSTRACT

The present invention provides a color display utilizing two complementary colors arranged in checker form. The color display comprises a plurality of pixels. Each pixel is composed of a kind of color. Multi-color displaying effect is achieved through combination and variation of brightness and gray-scale contrast of the pixels. The color is selected from a primary color and its complementary contrastive color, e.g., a primary color of red and its complementary color of cyan. The pixels of the primary color and its complementary color are alternately arranged in checker form. The present invention uses the same number of driving components as a convention monochromatic display, and has multi-color displaying function. The present invention has the advantages of a simple structure, easy manufacture, and a low cost.

### FIELD OF THE INVENTION

The present invention relates to a display and, more particularly, to an improved structure of a color display.

### BACKGROUND OF THE INVENTION

Along with the development of information technology, flat panel displays gradually become the main stream of electronic products. The flat panel displays can be divided into monochromatic type, multi-color type, and full-color type, wherein multi-color displaying effect of the multi-color type display utilizing two complementary colors can meet the requirements of some small portable displays such as personal digital assistant (PDA), mobile phones, digital cameras, video games, and digital watches.

In a color display, the output of its color image is composed of a plurality of pixels thereon. An image is formed by pixels of different colors and different brightness. As shown in FIG. 1, a color driving module of a prior art multi-color display utilizing two complementary colors comprises a plurality of tidily arranged pixels, wherein each pixel 12 is formed of a primary color 14 and its complementary color 16. In the driving circuit, two sets of data transmission lines (segment) 20 and a set of signal scan line (common) 18 are provided for longitudinally-arranged pixels and transversally-arranged pixels, respectively. Therefore, the design is complex, the manufacturing process is difficult, and the cost is high. Moreover, because each pixel of this kind of panel is controlled by two data transmission lines 20, the resolution is limited. Less information can be displayed in its effective area. Accordingly, the present invention aims to propose an improved structure of a color display to resolve the above problems in the prior art.

### SUMMARY OF THE INVENTION

The primary object of the present invention is to propose a color display to simplify the design of a color driving circuit thereof, to reduce the difficulty in manufacturing, and to decrease the cost.

Another object of the present invention is to provide a color display, which uses the same number of driving components as a conventional monochromatic display and has multi-color displaying function.

According to the present invention, the color displaying effect of a color display is achieved by controlling the brightness and gray-scale contrast of a plurality of pixels thereon. Each pixel is composed of a kind of color, which is alternately selected from a primary color of red and its complementary contrastive color of cyan.

The various objects and advantages of the present invention will be more readily understood from the following detailed description when read in conjunction with the appended drawings, in which:

### BRIEF DESCRIPTION OF THE DRAWINGS

FIG. 1 is a diagram of a prior art color driving module;

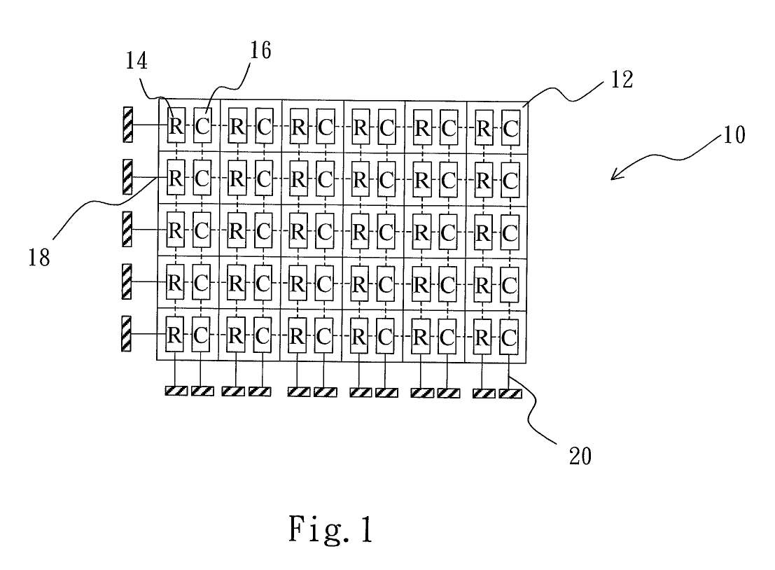

FIG. 2 is a diagram of the structure of a liquid crystal display;

FIG. 3 is a diagram of the structure of an organic light emitting diode; and

FIG. 4 is a diagram of a color display of the present invention.

### DETAILED DESCRIPTION OF THE PREFERRED EMBODIMENTS

The present invention is characterized in that color displaying effect is achieved by using a color display with two complementary colors arranged in checker form. The color display comprises a plurality of pixels, each having a kind of color. The color is selected from a primary color and its complementary color. The pixels of the primary color and its complementary color are alternately arranged in checker form. The characteristics of the present invention will be illustrated below by describing an embodiments of a liquid crystal display (LCD) and another embodiment of an organic light emitting diode (OLED).

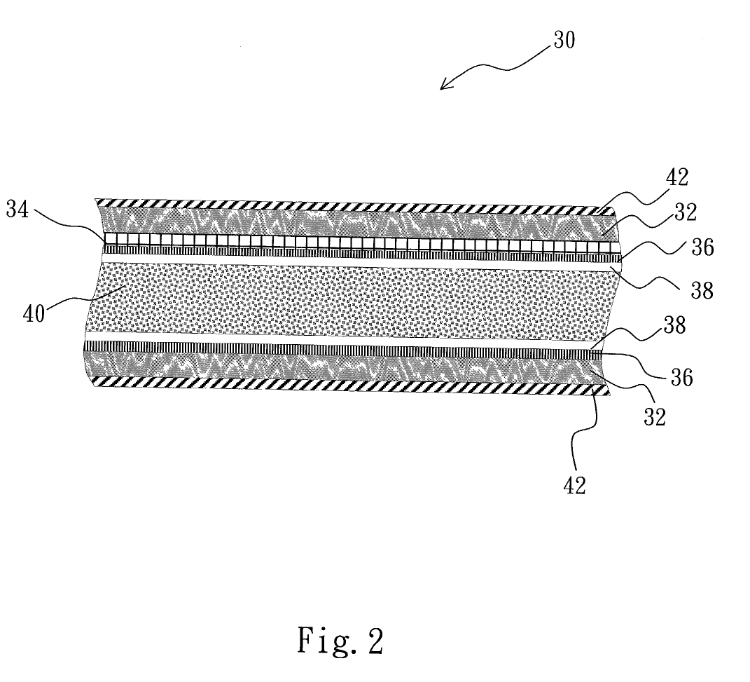

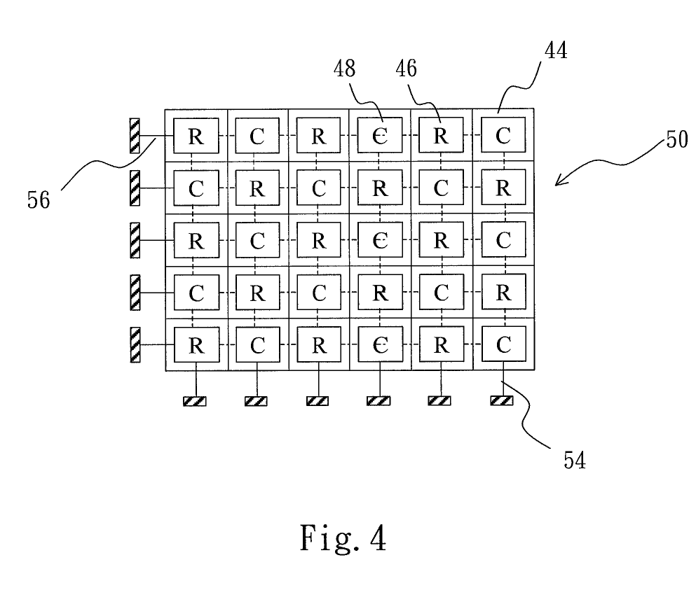

FIG. 2 shows an LCD 30, wherein a color filter 34, a transparent electrode plate 36, an alignment film 38, a liquid crystal layer 40, an alignment film 38, and a transparent electrode plate 36 are sandwiched from top to bottom between two transparent substrates 32. A polarizer 42 covers the outer surface of each transparent substrate 32. As shown in FIG. 4, a color display 50 usually uses a color filter, which comprises a plurality of pixels 44. Each pixel 44 has a kind of color. The color is selected from a primary color 46 and its complementary color 48. The pixels 44 of the primary color 46 and its complementary color 48 are alternately arranged in checker form. The pixels 44 of longitudinally-arranged lines and transversely-arranged lines are driven by a set of data transmission line 54 and a set of signal scan line 56, respectively. The data transmission line 54 and the signal scan line 56 are modules composed of indio tin oxide (ITO) respectively at the upper layer and the lower layer, and are uniformly arranged on the transparent electrode plates 36. When voltage signals are applied to the LCD 30, the pixels 44 will be controlled by the data transmission line 54 and the signal scan line 56 and matched by the arrangement of the liquid crystal layer 40 to form bright or dark points. The color brightness and gray-scale contrast of the pixels 44 are controlled according to the magnitudes of the voltage signals. The effect of a series of different colors can thus be obtained through combination and variation of the colors of the pixels 44.

Because each pixel 44 is composed of a kind of color, the drive of each pixel 44 can be accomplished by only controlling a data transmission line 54 and a signal scan line 56. Besides the design of the circuit structure of the whole color display is easier, the number of required data transmission lines 54 is reduced to a half of the number of the conventional data transmission lines 20. The present invention has multi-color displaying function, and uses the same number of driving components as a conventional monochromatic display. Furthermore, because each pixel can exhibit a single color, monochromatic effect can be displayed in both the longitudinal and transverse directions.

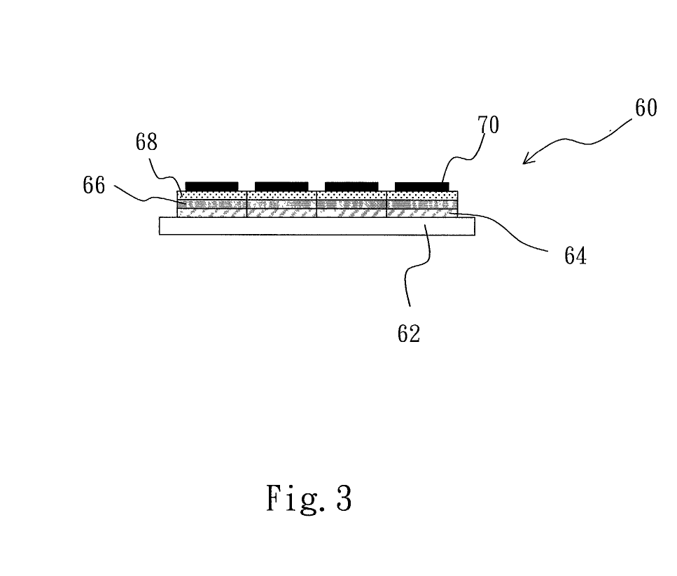

FIG. 3 shows an OLED 60, wherein an ITO electrode layer 64, a protection film 66, a light-emitting layer 68, and a metal electrode layer 70 are arranged in this order on a glass substrate 62. A layer of organic molecule light emitting material capable of emitting a primary color and its complementary color is coated on the light-emitting layer 68. Each pixel is made of organic molecule light emitting material. When voltages are applied, outer electrons of the organic molecules will be excited to jump to a higher energy level, and then drop to the lower energy level to emit photons of this energy difference. Therefore, the pixels can display colors. The ways of arrangement and connection of the emitting material is the same as those of the pixels in the above LCD and thus will not be further described.

Usually, the two colors used in the above color displays are red and cyan. If the primary color is blue, its complementary color is yellow. If the primary color is green, its complementary color is magenta.

To sum up, the color display of the present invention uses fewer electrodes and driving components. The present invention has the characteristics of a simple structure, easy manufacture, fewer driving components, and a reduced cost. The present invention can widely apply to displaying panels of portable products such as mobile phones, video games, PDAs, digital watches, and digital cameras. Additionally, the mechanism wherein each pixel is only composed of a kind of color can apply to displays using film super twisted nematic (FSTN).

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A color display utilizing two complementary colors arranged in checker form, whereby multi-color displaying effect is achieved by controlling brightness and gray-scale contrast of a plurality of pixels, each said pixel being composed of a kind of color, said color being selected from a primary color and its complementary contrastive color, said pixels of said primary color and said complementary contrastive color being alternately arranged.

2. The color display utilizing two complementary colors arranged in checker form as claimed in claim 1, wherein said pixels of said primary color and said complementary contrastive color are arranged in checker form.

3. The color display utilizing two complementary colors arranged in checker form as claimed in claim 1, wherein said pixels of each longitudinally-arranged line is controlled by a single data transmission line.
